(19) United States
(12) Patent Application Publication
(10) Pub. No.: US 2011/0036262 A1
(43) Pub. Date: Feb. 17, 2011

(54) Corrosion Prevention and Friction Reduction Coating and Low Temperature Process

(75) Inventors: William E. Olliges, Palm City, FL (US); Floyd Roberts, Treasure Island, FL (US); Gerry Arner, Clearwater, FL (US)

Correspondence Address: CAHN & SAMUELS LLP, 1100 17th STREET NW, SUITE 401, WASHINGTON, DC, 20036, US

(73) Assignee: Advanced Lubrication Technology, Inc., Agoura Hills, CA (US)

(21) Appl. No.: 12/868,986

(22) Filed: Aug. 26, 2010

Related U.S. Application Data
(63) Continuation-in-part of application No. 11/456,520, filed on Jul. 10, 2006, now abandoned.
(60) Provisional application No. 60/697,541, filed on Jul. 11, 2005.

(51) Int. Cl. E01B 7/00; C10M 163/00; B05D 3/10

(52) U.S. Cl. 104/130.01; 508/185; 508/137; 508/156; 427/299

(57) ABSTRACT

This invention relates to a structural coating comprising a liquid carrier (e.g., paint), a borate-based additive, and a dynamic stabilization material. The borate-based additive provides corrosion protection through electrochemical binding of active surface corrosive sites, lubrication enhancement through the creation and re-supply to a surface where friction contact occasionally occurs of a weak slip lane crystalline material which may be a locally formed product utilizing local atmospheric humidity, and a material for reaction with an initiator to provide for freezing point depression during coating application. The dynamic stabilization material creates a balance of stabilized material for supply of corrosion protection product, lubrication reduction product, and freezing point depression product.

### I. CROSS-REFERENCE TO RELATED APPLICATIONS

This application is a continuation-in-part application of U.S. application Ser. No. 11/456,520, filed Jul. 1, 2006 (which was published on Jan. 25, 2007), which claims priority from U.S. provisional Application Ser. No. 60/697,541, filed Jul. 11, 2005, the contents of which are hereby incorporated by reference in their entirety.

### II. FIELD OF THE INVENTION

The present invention relates to coatings for friction reduction and the prevention of corrosion. More particularly, the present invention relates to polymer carried lubrication and corrosion protection coatings suited for extreme environments.

### III. BACKGROUND OF THE INVENTION

Wheel lubrication is known in the art. Archeological evidence shows the use of tallow for wheel lubrication dating prior to 1400 B.C. The study of lubrication and frictional coefficients may be considered to have started in the late 1880's in Britain when Tower produced his studies on railroad car journal bearings in 1885. Since then, numerous artisans have engaged in the endeavor of finding lubricants and coatings suited to optimize the advantageous aspects of friction reduction in various environments.

Lubrication coatings fall typically into two broad categories, fluid film lubrication and dry film lubrication. Each of these prior art methods of providing lubrication suffer from their own respective set of drawbacks. To be more specific, in fluid film lubrication, the load on moving surfaces is supported entirely by the fluid between the opposing surfaces. Pressure on the film develops through the motion of the surfaces, this motion then in turn delivers the lubricant into a converging wedge-shaped zone. The behavior of the moving surfaces is totally dependent on the fluidity or viscous behavior of the lubricant. Film pressure and power loss are dependent on the viscosity of the lubricant as well as the configuration of the moving surfaces, and lubricant shear strength. Hydrodynamic or squeeze-film action cannot provide adequate load support in some instances for bearings lubricated with oil or water. In these cases, some prior artisans have tried pumping the lubricant into the moving surfaces in hopes of providing the necessary hydrodynamic or squeeze-film properties for bearings, particularly those used for handling heavy loads in low speed equipment. These prior art methods have proven futile in extremely high pressure situations. In these cases, to counter act situations within bearings and similar situations which would be considered extremely high pressure situations, some artisans have tried the use of additives. However, as will be appreciated by one of ordinary skill in the art, as extreme pressure additives function by chemical action, these additives may not be used where the metal surfaces will be severely eroded—a phenomena often encountered in harsh environments. Others in the art have suggested other approaches including increasing the lubricant or oil viscosity by means of an additive, lowering the unit bearing loading, improving the finish on the moving surfaces and using external pressurization as alternatives to the use of extreme-pressure additives. However, in any event, dry rubbing or dry sliding involving solid-to-solid contact occurs in almost all fluid lubrication systems as, for example, in machine start-up, run-in misalignment or inadequate clearance, reversal of direction of moving surfaces, or many unforeseen or unplanned interruptions in lubricant delivery. Moreover, conventional lubricants such as greases or oils also are not used on moving surfaces in extreme temperature, high vacuum, radiation or contamination environments. These circumstances and environments are usually addressed with dry film lubricants.

Dry lubricants present their own set of drawbacks. Typically, dry lubricants are applied as thin coatings or as particulate materials to reduce wear and friction of moving surfaces. As noted by Levy, these films or particulate materials may comprise or incorporate solid or particulate carbon-graphite, lead babbitt, bronze, aluminum, polyethylene or polytetrafluoroethylene solid or articulate materials in a binder where the film or particulates are adhered to one or both of the moving surfaces. The effectiveness of the dry lubricant film or particulates is controlled to some degree by the binder where solid or particulate lubricants are employed as well as conditions of use such as the load, surface temperatures generated during use, speed of the moving surfaces, hardening, fatigue, welding, recrystallization, oxidation and hydrolysis. In addition to these conditions potentially adversely affecting their effectiveness, as will be appreciated by one of ordinary skill in the art, dry lubricants typically are not able to provide any scrub resistance or weathering resistance, thereby greatly reducing their usefulness in any event.

The foregoing underscores some of the problems associated with convention lubrication coating methods and materials. Furthermore, the foregoing highlights the long-felt, yet unresolved need in the art for a lubrication coating that provides the advantageous features of both fluid film lubrication and dry film lubrication coatings. The foregoing also highlights the long-felt, yet unresolved need for a coating providing friction reduction and corrosion protection. In addition, the foregoing also highlights the long-felt, yet unresolved need for an effective lubrication coating suited for extreme environments including harsh weather conditions and harsh operating conditions.

### IV. SUMMARY OF THE INVENTION

Various embodiments of the present invention overcome the practical problems described above and offer additional advantages as well. Some embodiments of the present invention solve various of the above-described drawbacks by providing coatings providing friction reduction and corrosion protection. Others of the embodiments of the present invention solve various of the above-described drawbacks by providing lubrication coatings demonstrating longevity in extreme environments including harsh weather conditions and harsh operating conditions. Yet other embodiments of the present invention provide additional advantages to the foregoing such as providing coatings that are non-toxic and biodegradable and/or coatings that are inexpensive enough for mass production and use.

These and other advantages are obtained according to the present invention as described in more detail herein. Although not wishing to be bound by theory, various embodiments of the present invention may provide a synergistic effect wherein the compositions and processes described herein enhance the various advantages of the related art and also substantially obviate one or more of the limitations and disadvantages of the described prior compositions and processes.

According to one advantageous aspect of the invention, in at least one embodiment, there is provided a process and a material which provides for corrosion protection and lubrication in operating environments conventionally described as outside or exterior. According to another advantageous aspect of the invention, in at least one embodiment there is provided a process and a material which provides corrosion protection and lubrication in operating environments deemed extreme relating to the human comfort zone, whether it be temperature, precipitation, or otherwise. According to yet another advantageous aspect of the invention, in at least one embodiment there is provided a process and a material which provides corrosion protection and lubrication in the presence of corrosive forces.

In accordance with yet another advantageous aspect of the invention, in at least one embodiment, there is provided a process and a material adapted for applying a coating in a manner akin to a conventional paint. The advantageous aspect of this embodiment of the invention will be appreciated given that in applying a coating to a surface in temperatures below freezing, such as negative 20 degrees Fahrenheit, the attention to detail of the operator may momentarily wander. In order for any anticorrosive coating to be effective, it is important that surfaces be coated completely. Being able to apply the coatings of these embodiments of the invention in a manner typical to a conventional paint, a drawback of dry film lubricants (which are applied much like a grease agent) may be overcome and complete coatings of surfaces achieved.

According to one feature of the invention, there is provided a structural coating for simultaneously providing corrosion protection and a reduction of the coefficient of friction in an exterior benign or harsh environment comprising a polymeric resin, a borate-based additive, and a dynamic stabilization material. According to an aspect of the invention, the polymeric resin preferably comprises a resin from the durable structural coating class of resins, including but not limited to acrylics, urethanes, epoxies, vinyl acrylics, styrene butadienes, ureas, polyurea, silicones, and silicates.

According to another aspect of the invention, the borate-based additive comprises a single additive for simultaneously providing corrosion protection through electrochemical binding of active surface corrosive sites, lubrication enhancement through the creation and re-supply to a surface where friction contact occasionally occurs of a weak slip lane crystalline material which may be a locally formed product utilizing local atmospheric humidity, and a material for reaction with an initiator to provide for freezing point depression during coating application.

According to yet another aspect of the invention, the dynamic stabilization material creates a balance of stabilized material for supply of corrosion protection product, lubrication reduction product, and freezing point depression product.

According to a feature of the invention, the structural coating may include operative components for dispersing particles, providing surface activity for chemically and or mechanically binding the operative components to the polymeric resin following application of the coating, assisting with the coalescing of the structural resin, assisting with the control of liquid phase viscosity and assisting with the control of liquid phase PH.

According to another feature of the invention, for the borate-based additive, boric oxide is used as a starting point material providing corrosion protection through the transference of boric acid to the corrosive metallic interface, borate esters as liquid phase freezing point depression, and coefficient of friction reduction through the reaction with environmental humidity of boric oxide diffused to the surface.

According to a preferred embodiment, the dynamic stabilization material comprises a blend of 2,2,4 trimethyl-1,3 pentanediol monoisobutryate and 2,2,1 aminotmethyl propanol. An advantageous feature of this embodiment of the invention is that reaction of boric acid occurs with the diol monoester to form 2,2,4 trimethyl-1,3 pentanediol borate monoisobutryate (a borate ester).

According to yet another aspect of the invention there is provided a process of simultaneously passivating a surface subject to corrosive forces and reducing the frictional coefficient between the surface and a source of sliding, rolling, or sliding rolling friction comprising applying an initial coating followed by functional operation of said coating effecting passivation of a surface by continuously migrating boric acid to the specific areas to be passivated, wherein the migration is being driven by an established chemical potential gradient, and wherein the coating also reduces the coefficient of friction through migration of boric acid to the operative surface in contact with an environment of nonzero humidity, wherein the migration is also being driven through a locally derived chemical potential gradient.

An advantageous feature of this process is that in may be initiated at temperatures ranging from about 120 degrees Fahrenheit to about negative 36 degrees Fahrenheit.

Another advantageous feature of this process is that the process may be effectuated using the kinetic energy of atomized particle bombardment to initiate adhesive interfacial chemical reaction to occur. According to this feature of the invention, the interfacial chemical reaction may occur between the surface subject to corrosive forces and boric acid.

According to another advantageous feature of this process, a borate ester may stabilize the coating during initial application. According to this feature of the invention, the borate ester is itself stabilized during the application process through a dynamic balance of boric acid, borate ester, and anhydroxy groups.

According to yet another aspect of the invention, in some embodiments of the invention, the coatings are safe. According to this aspect of the invention, there are provided coatings having a finite ecological endpoint, wherein the endpoint is the time required for biodegradation of the coating. In accordance with the invention, there are provided coating having a breakdown time of 1 to 5 years or 3 to 10 years. Also according to this aspect of the invention, preferably the coatings of these embodiments of the present invention give off a VOC of less than 50 grams per liter of applied coating.

### V. DETAILED DESCRIPTION

While the present invention will be described in connection with coatings particularly useful railroads and other rail systems, it will be readily apparent to one of ordinary skill in the art that the present invention can be applied to a multiplicity of fields and uses. In general, the present invention may be used in any field for any task requiring a coating adapted for providing friction reduction and corrosion prevention. Moreover, the present invention may be used in any field for any task requiring a non-toxic and/or biodegradable lubricant or corrosion protectant or an inexpensive coating available in mass quantities.

In order to more fully detail and enabling description of the present invention, take the problems encountered in steel-rail and steel-wheel systems. Steel-rail and steel-wheel transportation systems including freight, passenger and mass transit systems suffer from extensive wear of mechanical components, such as wheels, rails and other rail components, such as ties. The origin of such wear of the mechanical components is typically considered a result of the frictional forces generated between the wheel and the rail during operation of the system. The wear between rail and track is not from a coating standpoint as relevant as the friction generated between components as the rail bed system responds to the passing weight of the railcar. The frictional forces generated during operation are certainly to blame for degradation of rail systems, however, less attended to is the condition of the components at the time of use. When corrosion (typically pitting, filliform, and crevice) mars the surface and produces asperities, the friction between operating surfaces increases dramatically. Often these asperities will pierce or destroy the lubricating film thus removing its beneficial effect entirely. Rust (oxidation of a metal) is an electrochemical phenomena. There are eight basic forms/mechanisms of corrosion each one creates an electrochemical cell in a different way. For crevice corrosion, uniform attack, and filliform corrosion preventing oxygen from getting to the exposed metal will typically stop the corrosion. This may be accomplished by a high density well applied coating capable of limited oxygen access. For Galvanic attack, pitting, fretting corrosion, stress corrosion, intergranular attack, dezinicification/leaching and erosion corrosion a coating will typically not prevent the corrosion from continuing/initiating without chemical interaction.

The stresses generated by the interaction between the wheel and the rail is most acute, at switches, where the railcar must move from one set of rails to another. Additionally the danger of derailment is highest at switches where partial switch closure and introduce a path for leaving the track. Switches are subject to a high volume of corrosive forces, typically in an unprotected environment. They must operate with a very high factor of safety through substantial weathering forces for years during which use may be frequent or intermittent. A switch failure may lead to a preponderance of undesirable consequences. Lubricants such as greases and oils must be replenished on to frequent a schedule and may fail from either too high a frequency of use or strong weathering conditions. Dry film lubricants while appropriate from a frequency of use standpoint do not tend to protect equipment sufficiently from corrosion due because they are typically difficult to apply in such a manner that they fully cover surfaces using in service application processes as described below. Additionally dry film lubricants do not posses a scrub resistance so that when forces are produced in directions other than those where a dry film lubricant material provides appropriate slip planes (basal plane in graphite) they are easily removed and rendered ineffective. Such forces are generated by weathering from rail, snow, ground movement, etc.

A presently preferred embodiment of the current invention is a process of simultaneously passivating a surface subject to corrosive forces and reducing the frictional coefficient between this surface and a surface which would be considered a source of sliding, rolling, or sliding rolling friction. The process involves applying a coating using conventional coating application procedures such as spraying brushing or rolling the coating onto the surfaces requiring protection. This first process step may occur in ambient conditions ranging from 120 deg F. to negative 36 deg F. Within the coating application in the extremes of this range is facilitated by stabilizing the coating using a borate ester. In turn this borate ester borate may itself be stabilized during the application process through a dynamic balance of boric acid, borate ester, and anhydroxy groups. The adhesion between the applied surface and the preformed coating process may be effected by using the kinetic energy of atomized particle bombardment to initiate adhesive interfacial chemical reaction to occur. Additionally, the adhesion may be promoted by using the kinetic energy of atomized particle bombardment to initiate adhesive interfacial chemical reaction to occur between the applied surface subject to corrosive forces and boric acid. Once the coating has been applied to the surface boric acid is continuously migrated through a chemical potential gradient to the metallic surface currently and previously subject to corrosive forces and once the coating has fully formed a dynamic balance is set up on the surface where friction occurs so that boric acid is continually applied to this surface. It is important to note that unlike a dry lubricant the operative surface for reduction of friction must be in contact with an environment of nonzero humidity.

As society has become more aware of the importance of ecological compatibility it is important that any product left exposed in the environment biodegrade within an appropriate time frame. The process described heretofore may be effected in such a way that applied materials biodegrade within a range of one to twenty years based on components described in later paragraphs. Of additional relevance to the process is that during the initial coating application it is important that operators and other stakeholders in the process add as little volatile organic content (VOC) into the atmosphere as possible. With that in mind the current process is effected in such a manner that there is less than 50 grams of VOC per liter of coating applied.

The coating which is also claimed in this application is a structural coating for simultaneously providing corrosion protection and a reduction of the coefficient of friction in a exterior benign or extreme environment where the coating is comprising a polymeric resin from the durable structural coating class of resins; examples of which would be acrylics, urethanes, epoxies, vinyl acrylics, styrene butadienes, ureas, polyurea, silicones, and silicates; a single additive for simultaneously providing corrosion protection through electrochemical binding of active surface corrosive sites, lubrication enhancement through the creation and resupply to a surface where frictional contact occasionally occurs of a weak slip plane crystalline material which may be a locally formed product utilizing local atmospheric humidity, and material for reaction with an initiator to provide for freezing point depression during coating application; and a dynamic stabilization material which creates a balance of stabilized material for supply of corrosion protection product, lubrication reduction product, and freezing point depression product. This material is formed when boric oxide is used as a starting point material providing corrosion protection through the transference of boric acid to the corrosive metallic interface, Borate Esters as liquid phase freezing point depression, and coefficient of friction reduction through the reaction with environmental humidity of boric oxide diffused to the surface. The reaction can take place in an acidic environment such as one catalyzed by the acrylic acid polymer. These borate esters are well known as plasticizers and flame retardants. The reaction of boric acid may occur with said diol monoester to form 2,2,4 trimethyl-1,3 pentanediol borate monoisobutryate as said borate ester. To provide some of the aforementioned process enhancements it is also beneficial for the coating to contain components for dispersing particles during coating formation. The coating may additionally provide during formulating additives for creating surface activity for chemically and or mechanically binding operative components to the polymeric resin following application of the coating. Useful additives also typically include materials which assist with the coalescing of said structural resin and materials which assist with the control of liquid phase viscosity, and control of liquid phase Ph. The dynamic stabilization material mentioned may be a blend of 2,2,4 trimethly-1,3 pentanediol monoisobutyrate and 2,2,1 Amino Methyl Propanol.

This invention has specific relevance to railway switches such that a section of railway track which may be mechanically moved from one position to another position without disassembly or detachment from the ground may be effectively coated with a composition comprising a polymeric resin from the durable structural coating class of resins. Some examples of such resins would be acrylics, urethanes, epoxies, vinyl acrylics, styrene butadienes, ureas, polyurea, silicones, and silicates. This coating would also contain a single additive for simultaneously providing corrosion protection through electrochemical binding of active surface corrosive sites, lubrication enhancement through the creation and resupply to all operative surfaces where frictional contact occasionally occurs of a weak slip plane crystalline material which may be a locally formed product utilizing local atmospheric humidity, and material for reaction with an initiator to provide for freezing point depression during coating application. During application and construction of the railway switch a dynamic stabilization material would be used which creates a balance of stabilized material for supply of corrosion protection product, lubrication reduction product, and freezing point depression product.

A railway switch coated with a composition on surfaces other than the railcar wheel interface surface is of very high commercial relevance. Such a switch would consist of a switch and a coating comprising; a polymeric resin from the durable structural coating class of resins; examples of which would be acrylics, urethanes, epoxies, vinyl acrylics, styrene butadienes, ureas, polyurea, silicones, and silicates; a single additive for simultaneously providing corrosion protection through electrochemical binding of active surface corrosive sites, lubrication enhancement through the creation and resupply to all operative surfaces where frictional contact occasionally occurs of a weak slip plane crystalline material which may be a locally formed product utilizing local atmospheric humidity, and material for reaction with an initiator to provide for freezing point depression during coating application; and a dynamic stabilization material which creates a balance of stabilized material for supply of corrosion protection product, lubrication reduction product, and freezing point depression product.

In at least one embodiment of the invention, the coating mixture includes a liquid carrier (e.g., paint, polymeric resin) and a boric oxide additive. The liquid carrier provides a vehicle for delivering the boric oxide additive to the surface subject to corrosive forces. In at least one embodiment, the liquid carrier is not a load bearing surface and does not have any lubricating properties-only the boric oxide that the liquid carrier carries is load-bearing and has lubricating properties. In another embodiment, the liquid carrier is a vehicle to coat a ferrous surface with boric acid, which (under frictional conditions) will heat, and react to form a boric oxide.

In addition, the carrier is a liquid that can penetrate areas that grease, solids, or semi-solid resins cannot, and also delivers the boric acid additive. The liquid carrier (e.g., paint) also functions as a marker/dye for indicating the presence of boric acid on the surface. Therefore, the presence of the liquid carrier on the surface indicates where the coating mixture has penetrated to. On the other hand, the absence of the liquid carrier may indicate wear on the surface, thereby alerting maintenance workers that reapplication of the coating mixture is needed.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings. The exemplary and alternative embodiments described above may be combined in a variety of ways with each other. Furthermore, the dimensions, shapes, sizes, and number of the various pieces illustrated in the Figures may be adjusted from that shown.

Furthermore, those skilled in the art will appreciate that various adaptations and modifications of the above-described exemplary embodiments can be configured without departing from the scope and spirit of the invention. Therefore, it is to be understood that, within the scope of the appended claims, the invention may be practiced other than as specifically described herein.

What is claimed is:

1. A structural coating comprising:
a liquid carrier lacking lubricating properties, said liquid carrier including a dye to indicate the presence of said boric oxide on said surface;
a borate-based additive, wherein said borate based additive is supplied in an amount sufficient to electrochemically bind to active surface corrosive sites of a substrate to form a corrosion protection product, in an amount sufficient to form a lubricant product on a treated surface in the presence of atmospheric humidity, and in an amount sufficient to react with an inhibitor to lower said coating's freezing point during application by forming a freezing point depression product; and
a dynamic stabilization product in an amount sufficient to create a balance of stabilized material for supply of corrosion protection product, lubrication product and freezing point depression product.

2. The coating of claim 1, wherein said liquid carrier is selected from the class of durable structural coating resins comprising acrylics, urethanes, epoxies, vinyl acrylics, styrene butadienes, ureas, polyurea, silicones, and silicates.

3. The coating of claim 2, wherein said borate-based additive is boric oxide and said corrosion protection product is a result of transference of boric acid to a corrosive metallic interface, said lubrication product is a result of reaction of environmental humidity and boric oxide diffused to an ambient surface, and said freezing point depression product comprises borate ester.

4. The coating of claim 3, wherein said dynamic stabilization material is a blend of 2,2,4 trimethly-1,3 pentanediol monoisobutyrate and 2,2,1 AminotMethyl Propanol.

5. The coating of claim 4, wherein reaction of boric acid occurs with said diol monoester to form 2,2,4 trimethyl-1,3 pentanediol borate monoisobutryate as said borate ester.

6. The coating of claim 1, further comprising operative components for dispersing particles, said operative components providing surface activity for binding said operative components to said liquid carrier following application of said coating, assisting with coallescing of said liquid carrier, assisting with the control of liquid phase viscosity, and assisting with control of liquid phase pH.

7. A process of simultaneously passivating a surface subject to corrosive forces and reducing the frictional coefficient between said surface and a source of sliding, rolling, or sliding rolling friction, comprising:
adding boric oxide to a liquid carrier to form a coating mixture, said liquid carrier lacking lubricating properties;
applying said coating mixture to said surface;
effecting passivation of said surface by continuous migration of boric acid to specific areas to be passivated, said migration being driven by an established chemical potential gradient; and
reducing the coefficient of friction through migration of boric acid to an operative surface in contact with an environment of nonzero humidity, said migration also being driven through a locally derived chemical potential gradient.

8. The process of claim 7, wherein said coating mixture is applied in ambient conditions ranging from 120 deg F. to negative 36 deg F.

9. The process of claim 8, further comprising the step of using kinetic energy of atomized particle bombardment to initiate adhesive interfacial chemical reaction to occur.

10. The process of claim 9, wherein said interfacial chemical reaction occurs between said surface subject to corrosive forces and boric acid.

11. The process of claim 8, further comprising the step of stabilizing said coating mixture during said applying step with a borate ester.

12. The process of claim 11, further comprising the step of stabilizing said borate ester during the applying step through a dynamic balance of boric acid, borate ester, and anhydroxy groups.

13. The process of claim 7, further comprising the step of biodegrading said coating mixture.

14. The process of claim 13, wherein said biodegrading step takes about between 1 and 5 years based on expected ambient conditions.

15. The process of claim 14, wherein said biodegrading step takes between about 3 and 10 years based on ambient conditions.

16. The process of claim 7, wherein the VOC given off by said process is less than 50 grams per liter of applied coating mixture.

17. A section of railway track which may be mechanically moved from one position to another position without disassembly or detachment from the ground coated with a composition comprising:
a liquid carrier selected from the durable structural coating class of resins comprising acrylics, urethanes, epoxies, vinyl acrylics, styrene butadienes, ureas, polyurea, silicones, and silicates, said liquid carrier lacking lubricating properties, and said liquid carrier including a dye to indicate the presence of said boric oxide on said surface;
a single additive for simultaneously providing corrosion protection through electrochemical binding of active surface corrosive sites, lubrication enhancement through the creation and resupply to all operative surfaces where frictional contact occasionally occurs of a weak slip plane crystalline material which may be a locally formed product utilizing local atmospheric humidity, and material for reaction with an initiator to provide for freezing point depression during coating application; and
a dynamic stabilization material which creates a balance of stabilized material for supply of corrosion protection product, lubrication reduction product, and freezing point depression product.

18. A railway switch coated with a composition on surfaces other than the railcar wheel interface surface comprising:
a liquid carrier selected from the group of durable structural coating class of resins comprising acrylics, urethanes, epoxies, vinyl acrylics, styrene butadienes, ureas, polyurea, silicones, and silicates, said liquid carrier lacking lubricating properties, and said liquid carrier including a dye to indicate the presence of said boric oxide on said surface;
a single additive for simultaneously providing corrosion protection through electrochemical binding of active surface corrosive sites, lubrication enhancement through the creation and resupply to all operative surfaces where frictional contact occasionally occurs of a weak slip plane crystalline material which may be a locally formed product utilizing local atmospheric humidity, and material for reaction with an initiator to provide for freezing point depression during coating application; and
a dynamic stabilization material which creates a balance of stabilized material for supply of corrosion protection product, lubrication reduction product, and freezing point depression product.

19. The process of claim 11, wherein said step of stabilizing comprises providing corrosion protection, lubrication reduction, and freezing point depression.

20. A process of simultaneously passivating a surface subject to corrosive forces and reducing the frictional coefficient between said surface and a source of sliding, rolling, or sliding rolling friction, comprising:
adding boric oxide to a liquid carrier to form a coating mixture, said liquid carrier lacking lubricating properties;
applying said coating mixture to said surface;
effecting passivation of said surface by continuous migration of boric acid to specific areas to be passivated, said migration being driven by an established chemical potential gradient;
reducing the coefficient of friction through migration of boric acid to an operative surface in contact with an environment of nonzero humidity, said migration also being driven through a locally derived chemical potential gradient; and
stabilizing said coating mixture during said applying step with a borate ester, wherein said stabilizing comprises providing corrosion protection, lubrication reduction, and freezing point depression.

21. The process of claim 20, wherein said coating mixture is applied in ambient conditions ranging from 120 deg F. to negative 36 deg F., and wherein the VOC given off by said process is less than 50 grams per liter of applied coating mixture.

22. The process of claim 21, further comprising the step of using kinetic energy of atomized particle bombardment to initiate adhesive interfacial chemical reaction to occur, wherein said interfacial chemical reaction occurs between said surface subject to corrosive forces and boric acid.

23. The process of claim 20, further comprising the step of stabilizing said borate ester during the applying step through a dynamic balance of boric acid, borate ester, and anhydroxy groups.

24. The process of claim 20, further comprising the step of biodegrading said coating mixture, wherein said biodegrading step takes about between 1 and 5 years based on expected ambient conditions, and wherein said biodegrading step takes between about 3 and 10 years based on ambient conditions.

25. A process of simultaneously passivating a surface subject to corrosive forces and reducing the frictional coefficient between said surface and a source of sliding, rolling, or sliding rolling friction, comprising:
adding boric oxide to a liquid carrier to form a coating mixture, said liquid carrier lacking lubricating properties;
applying said coating mixture to said surface, said liquid carrier including a dye to indicate the presence of said boric oxide on said surface;
effecting passivation of said surface by continuous migration of boric acid to specific areas to be passivated, said migration being driven by an established chemical potential gradient;
reducing the coefficient of friction through migration of boric acid to an operative surface in contact with an environment of nonzero humidity, said migration also being driven through a locally derived chemical potential gradient;
stabilizing said coating mixture during said applying step with a borate ester, wherein said stabilizing comprises providing corrosion protection, lubrication reduction, and freezing point depression; and
stabilizing said borate ester during the applying step through a dynamic balance of boric acid, borate ester, and anhydroxy groups.

26. The process of claim 25, wherein said coating mixture is applied in ambient conditions ranging from 125 deg F. to negative 36 deg F., and wherein the VOC given off by said process is less than 50 grams per liter of applied coating mixture.

27. The process of claim 21, further comprising the step of using kinetic energy of atomized particle bombardment to initiate adhesive interfacial chemical reaction to occur, wherein said interfacial chemical reaction occurs between said surface subject to corrosive forces and boric acid.

28. The process of claim 25, further comprising the step of biodegrading said coating mixture, wherein said biodegrading step takes about between 1 and 5 years based on expected ambient conditions, and wherein said biodegrading step takes between about 3 and 10 years based on ambient conditions.
